(19) United States
(12) Patent Application Publication
(10) Pub. No.: US 2026/0369263 A1
(43) Pub. Date: Nov. 19, 2026

(54) Machine-Learned Selection of Textual Inputs for Generative Audio Models

(71) Applicant: Google LLC, Mountain View, CA (US)

(72) Inventors: Marco Tagliasacchi, Lugano (CH); Matthew Sharifi, Kilchberg (CH); Manuel Tragut, Zug (CH); Neil Zeghidour, Paris (FR); Zalán Borsos, Zürich (CH)

(21) Appl. No.: 19/475,974

(22) PCT Filed: Apr. 20, 2023
(86) PCT No.: PCT/US2023/019293

§ 371 Date: Oct. 16, 2025

(51) Int. Cl. G10L 13/08; G10H 1/00; G10L 13/027; G10L 13/033; G10L 13/047

(52) U.S. Cl. CPC G10L 13/08; G10H 1/0025; G10L 13/027; G10L 13/033; G10L 13/047; G10H 2210/111

(57) ABSTRACT

A textual query for generation of audio is obtained. The generation of audio is performed with a machine-learned generative audio model grouping including a plurality of machine-learned generative audio models each trained to generate audio of a respective audio content type of a plurality of audio content types. A machine-learned language model is used to select a first portion of the textual query as an input for a first machine-learned generative audio model of the plurality of machine-learned generative audio models, wherein the first machine-learned generative audio model is trained to generate audio of a first audio content type of the plurality of audio content types. Processing of the first portion of the textual query with the first machine-learned generative audio model is caused to obtain an audio output comprising audio of the first audio content type.

### FIELD

The present disclosure relates generally to generation of audio using multiple generative audio models for generation of audio outputs. More particularly, the present disclosure relates to selection of inputs to generative audio models from a textual query using a machine-learned language model.

### BACKGROUND

In recent years, machine-learned models have been used to generate various types of data (e.g., textual content, audio data, video data, 3D modeling data, etc.) in an increasingly sophisticated manner. Some models may be trained on extremely large quantities of data so that the models can perform a wide variety of tasks. For example, training generative text models (such as large language models) on large sets of training data leads to models that exhibit high accuracy that can also perform multiple types of tasks. Conversely, other types of models are trained on smaller sets of data to perform specific tasks. For example, a generative audio model may be trained to generate a specific type of audio content (e.g., music, speech, etc.).

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method includes obtaining a textual query for generation of audio, wherein the generation of audio is performed with a machine-learned generative audio model grouping comprising a plurality of machine-learned generative audio models each trained to generate audio of a respective audio content type of a plurality of audio content types. The method includes using, by the computing system, a machine-learned language model to select a first portion of the textual query as an input for a first machine-learned generative audio model of the plurality of machine-learned generative audio models, wherein the first machine-learned generative audio model is trained to generate audio of a first audio content type of the plurality of audio content types. The method includes causing, by the computing system, processing of the first portion of the textual query with the first machine-learned generative audio model to obtain an audio output comprising audio of the first audio content type.

Another example aspect of the present disclosure is directed to a computing system. The computing system includes one or more processors and one or more non-transitory computer-readable media that store instructions that, when executed by the one or more processors, cause the one or more processors to perform operations. The operations include obtaining a textual query for generation of audio, wherein the generation of audio is performed with a machine-learned generative audio model grouping comprising a plurality of machine-learned generative audio models each trained to generate audio of a respective audio content type of a plurality of audio content types. The operations include using a machine-learned language model to respectively select one or more portions of the textual query as inputs for one or more machine-learned generative audio models of the plurality of machine-learned generative audio models; wherein the one or more machine-learned generative audio models are trained to generate audio of one or more respective audio content types of a plurality of audio content types. The operations include causing processing of the one or more portions of the textual query with the one or more machine-learned generative audio models to obtain one or more audio outputs comprising audio of the one or more respective audio types.

Another example aspect of the present disclosure is directed to one or more non-transitory computer-readable media that store instructions that, when executed by one or more processors, cause the one or more processors to perform operations. The operations include obtaining, from a user computing device, a textual query for generation of audio, wherein the generation of audio is performed with a machine-learned generative audio model grouping comprising a plurality of machine-learned generative audio models each trained to generate audio of a respective audio content type of a plurality of audio content types. The operations include processing a prompt with a machine-learned language model to obtain a language output indicating two or more portions of the textual query as being inputs for two or more respective machine-learned generative audio models of the plurality of machine-learned generative audio models, wherein the prompt comprises the textual query and information indicative of a task to determine whether the textual query includes inputs for the two or more machine-learned generative audio models. The operations include respectively processing the two or more portions of the textual query with the two or more machine-learned generative audio models to obtain two or more audio outputs comprising audio of the two or more respective audio types. The operations include mixing the two or more audio outputs to obtain a mixed audio output. The operations include providing the mixed audio output to the user computing device.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs machine-learned selection of textual inputs for generative models according to example embodiments of the present disclosure.

FIG. 1B depicts a block diagram of an example computing device that performs selection of inputs for machine-learned generative audio models according to example embodiments of the present disclosure.

FIG. 1C depicts a block diagram of an example computing device that performs selection of inputs for machine-learned generative audio models according to example embodiments of the present disclosure.

FIG. 2 depicts a block diagram of an example grouping of machine-learned generative models according to example embodiments of the present disclosure.

FIG. 3A depicts a data flow diagram of an example machine learning module that optimizes selection of a first portion of a textual query as an input for a first generative audio model according to example embodiments of the present disclosure.

FIG. 3B depicts a data flow diagram of the example machine learning module that optimizes selection of a second portion of the textual query as an input for a second generative audio model according to example embodiments of the present disclosure.

FIG. 4 is a data flow diagram for interactions between a user computing device and a computing system that provides a generative audio service using a machine learning module according to some implementations of the present disclosure.

FIG. 5 is a data flow diagram for generation of a multi-track output using a machine-learned generative model grouping that includes multiple generative models trained to generate different types of content according to some implementations of the present disclosure.

FIG. 6 depicts a flow chart diagram of an example method to perform machine-learned selection of textual inputs for generative audio models according to example embodiments of the present disclosure.

Reference numerals that are repeated across plural figures are intended to identify the same features in various implementations.

### DETAILED DESCRIPTION

### Overview

Generally, the present disclosure is directed to selection of inputs to generative audio models from a textual query using a machine-learned language model. More specifically, in some scenarios, optimal model performance can be achieved by training a variety of generative models to perform specific tasks, rather than training a single model to perform multiple tasks. In particular, generative audio models can exhibit superior performance when trained to perform specific generative audio tasks (e.g., training one model to perform a text-to-speech task while training another model to perform a text-to-music task). However, when a textual query specifies audio that would require the performance of multiple generative audio tasks, the task parameters must be separately extracted from the query so that each task can be performed.

For example, assume a user of a user computing device provides the textual query “A man speaking English with background piano music” to a computing system that provides a generative audio service. The computing system can determine that the audio specified by the textual query necessitates the performance of both a generative music audio task and a generative speech audio task. The computing system can use a machine-learned language model (e.g., a large language model (LLM), etc.) to select a first portion of the textual query as an input for a machine-learned generative speech model trained to generate speech from a text input. Specifically, the computing system can use the machine-learned language model to select the portion of textual content “A man speaking English” from the textual query. The computing system can process the first portion of the textual query with the machine-learned generative speech model to obtain an audio output that includes audio of a man speaking English.

The computing system can use the machine-learned language model to select a second portion of the textual query as an input for a machine-learned generative music model trained to generate music from a text input. Specifically, the computing system can use the machine-learned language model to select the portion of textual content “background piano music” from the text query. The computing system can process the second portion of the textual query with the machine-learned generative music model to obtain an audio output that includes audio of piano music.

Once performance of the multiple generative audio tasks is complete, the computing system can mix the audio outputs to obtain a mixed audio output. This mixed audio output can be provided to the user computing device associated with the user. In such fashion, the computing system can semantically extract inputs from a textual query using a large language model to generate optimal text inputs to multiple machine-learned generative audio models, therefore enabling optimal performance using task-specific generative audio models.

Aspects of the present disclosure provide a number of technical effects and benefits. As one example technical effect and benefit, large audio models can be used when multiple generative audio tasks must be performed to return a desired output (e.g., performance of both generative music and speech tasks, etc.). However, the outputs produced by generalized audio models can be substantially less accurate than the mixed outputs of multiple task-specific generative audio models. Furthermore, both the training stage (i.e., training the model) and inference stage (i.e., using the model) of a large audio model requires an enormous expenditure of compute resources (e.g., power, memory, compute cycles, storage, bandwidth, etc.) in comparison to the training and inference stages of smaller, task-specific generative audio models. Accordingly, by optimizing the extraction of textual inputs for task-specific generative audio models, implementations of the present disclosure eliminate the inefficiencies associated with large audio models while providing outputs with superior accuracy.

With reference now to the Figures, example embodiments of the present disclosure will be discussed in further detail.

### Example Devices and Systems

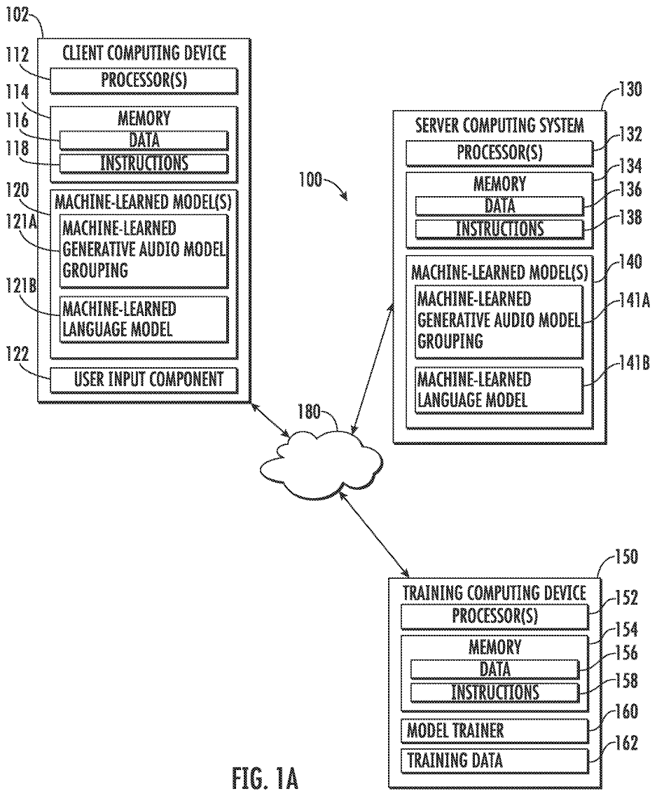

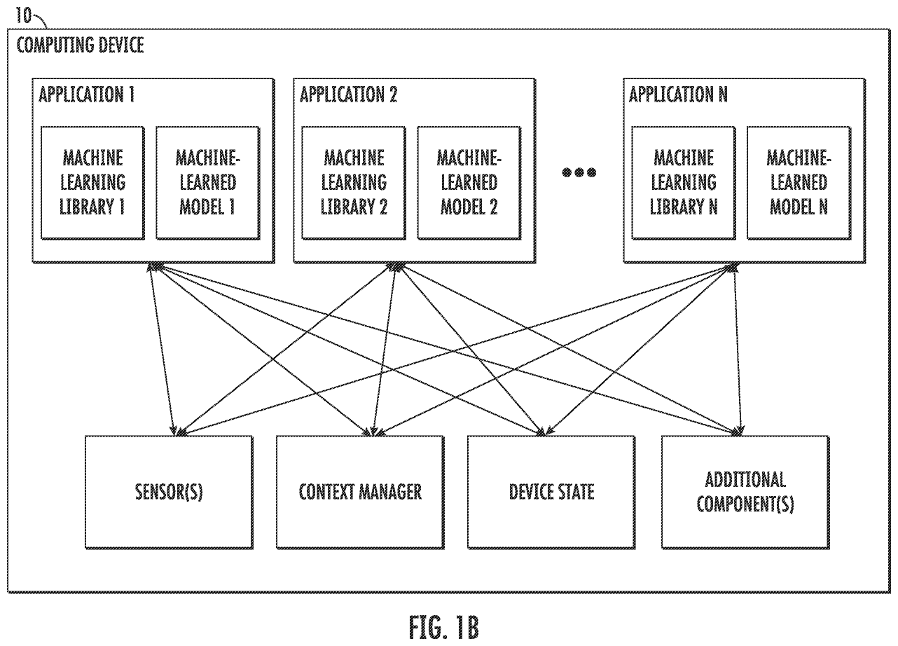

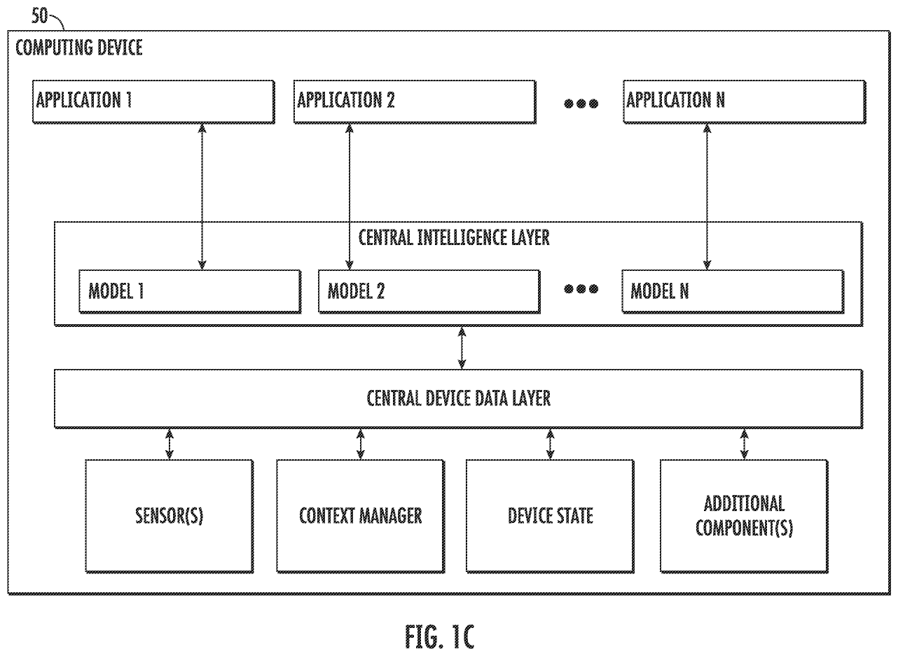

FIG. 1A depicts a block diagram of an example computing system 100 that performs machine-learned selection of textual inputs for generative models according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

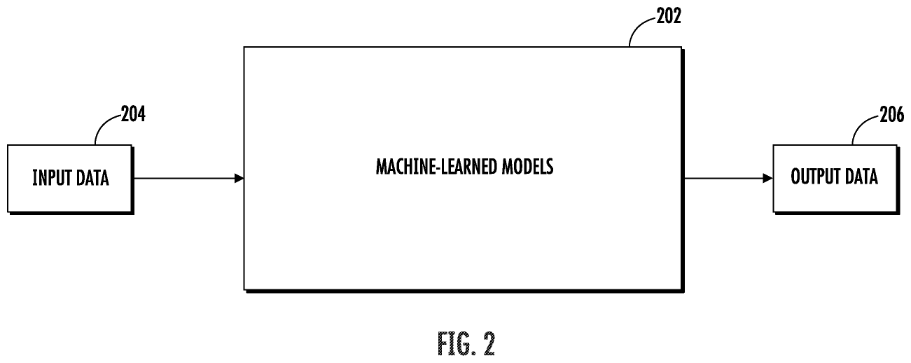

In some implementations, the user computing device 102 can store or include a plurality of machine-learned models 120. For example, the plurality of machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 2-4.

In some implementations, the plurality of machine-learned models 120 can be received from the server computing system 130 over network 180, stored in the user computing device memory 114, and then used or otherwise implemented by the one or more processors 112. In some implementations, the user computing device 102 can implement multiple parallel instances of a single grouping of models 120 (e.g., to perform parallel input extraction for generative audio models across multiple instances of the models 120).

More particularly, the plurality of machine-learned models 120 can include a machine-learned generative model grouping 121A. The machine-learned generative model grouping 121A can be, or otherwise include, multiple machine-learned generative models, such as machine-learned generative audio models that are each trained to perform a different generative audio task. For example, the machine-learned generative model grouping 121A can include a machine-learned generative speech model trained to perform a generative speech audio task (e.g., generating words spoken by a human) based on a textual input. For another example, the machine-learned generative model grouping 121A can include a machine-learned generative music model trained to perform a generative music audio task based on a textual input. For another example, the machine-earned generative model grouping 121A can include a machine-learned generative background audio model trained to perform a generative background audio task based on a textual input (e.g., insect sounds at night, car sounds outside of a café, etc.). For another example, the machine-learned generative audio grouping 121A can include a machine-learned generalized audio model trained to perform two (or more) different generative audio tasks. For yet another example, the machine-learned generative model grouping 121A can include multiple other types of generative models (e.g., generative video models, generative image models, generative representation models, etc.).

The plurality of machine-learned models 120 can include a machine-learned language model 121B. Generally, a machine-learned language model refers to a model that is trained to determine a semantic understanding of a textual input for the performance of multiple types of language tasks. For example, given a text query, the machine-learned language model 121B may be prompted to perform a language task that provides a text response to the query. For another example, the machine-learned language model 121B may be prompted to extract inputs from a text query based on an association between the semantic meaning of the inputs and the tasks performed by specific models.

As a particular example, assume that the user computing device 102 obtains a textual query from a user of the user computing device 102. The user computing device 102 can process the textual query with the machine-learned language model 121B to select a first portion of the textual query for processing with a machine-learned generative speech model of the machine-learned generative model grouping 121A and a second portion of the textual query for processing with a machine-learned generative music model of the machine-learned generative speech model of the machine-learned generative model grouping 121A.

Additionally or alternatively, a plurality of machine-learned models 140 can be included in or otherwise stored and implemented by the server computing system 130 that communicates with the user computing device 102 according to a client-server relationship. For example, the plurality of machine-learned models 140 can be implemented by the server computing system 130 as a portion of a web service (e.g., a generative audio service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include a plurality of machine-learned models 140. For example, the plurality of machine-learned models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 2-4.

In particular, the plurality of machine-learned models 140 can include a machine-learned generative model grouping 141A and a machine-learned language model 141B as described with regards to model grouping 121A and model 121B of the user computing device 102. To follow the previous example, in some implementations, the user computing device 102 can receive a textual query from the user associated with the user computing device 102. The user computing device 102 can use the machine-learned language model 121B to select a first portion of the textual query as an input for a machine-learned speech generation model of the machine-learned generative model grouping 141A. Alternatively, in some implementations, the user computing device 102 may obtain a textual query from a user of the user computing device 102, and then provide the textual query to the server computing system 130 without any processing of the textual query with a language model.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training examples can be provided by the user computing device 102. Thus, in such implementations, the models 120 provided to the user computing device 102 can be trained by the training computing system 150 on user-specific data received from the user computing device 102. In some instances, this process can be referred to as personalizing the model.

In some implementations, the model trainer 160 can train the models 120 and/or 140 based on a set of training data 162. In particular, the model trainer can, in some implementations, tune the machine-learned language model 121B for selection of textual inputs for generative audio models. For example, the training data 162 can include textual queries and associated ground truths indicative of textual inputs to be optimally selected from the textual queries. In such fashion, the model trainer 160 can tune the machine-learned language model 121B for optimal selection of textual inputs for generative audio models from the textual query.

Additionally, or alternatively, in some implementations, the model trainer 160 can personalize the models 120 and/or 140 based on user feedback information. For example, the server computing system 130 can receive a textual query from the user computing device 102. The server computing system 130 can use the machine-learned language model 141B to select a portion of the textual query as an input for a machine-learned generative music model of the machine-learned generative model grouping 141A. The server computing system 130 can process the portion of the textual query with the machine-learned generative music model to obtain an audio output (e.g., music audio with piano instrumentals, etc.). The server computing system 130 can provide the audio output to the user computing device 102 and, in response, can receive user feedback information indicating feedback for the audio output (e.g., a dislike for music audio with piano instrumentals, etc.). Based on the user feedback information, the model trainer 160 can personalize the machine-learned generative music model (e.g., an instance of the model specific to the user) based on the user's preferences.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

In some implementations, the input to the machine-learned model(s) of the present disclosure can be image data. The machine-learned model(s) can process the image data to generate an output. As a particular example, the machine-learned model(s) can process an image input to generate a textual representation of the input that can serve as a textual query for selection of textual inputs for models of the machine-learned generative audio model grouping. As another example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the task may comprise generating an embedding for input data (e.g. input audio or visual data).

In some cases, the input includes audio data representing a spoken utterance and the task is a speech recognition task. The output may comprise a text output which is mapped to the spoken utterance. In some cases, the task comprises encrypting or decrypting input data.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs selection of inputs for machine-learned generative audio models according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs selection of inputs for machine-learned generative audio models according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

FIG. 2 depicts a block diagram of an example grouping of machine-learned generative models 200 according to example embodiments of the present disclosure. In some implementations, the plurality of machine-learned models 200 is trained to receive a set of input data 204 descriptive of a textual query and, as a result of receipt of the input data 204, provide output data 206 that is, or otherwise includes, multiple audio output that correspond to portions of textual query. In particular, the plurality of machine-learned models 200 are trained to receive a set of input data 204 descriptive of a textual query, and select multiple portions of the input data 204 as inputs to multiple task-specific generative models to generate multiple outputs. Thus, in some implementations, the plurality of machine-learned models 200 can include a machine-learned language model that is operable to select portions of a textual query as inputs, and can also include machine-learned generative models, such as generative audio models, to process the portions of the textual query to generate outputs, such as audio outputs.

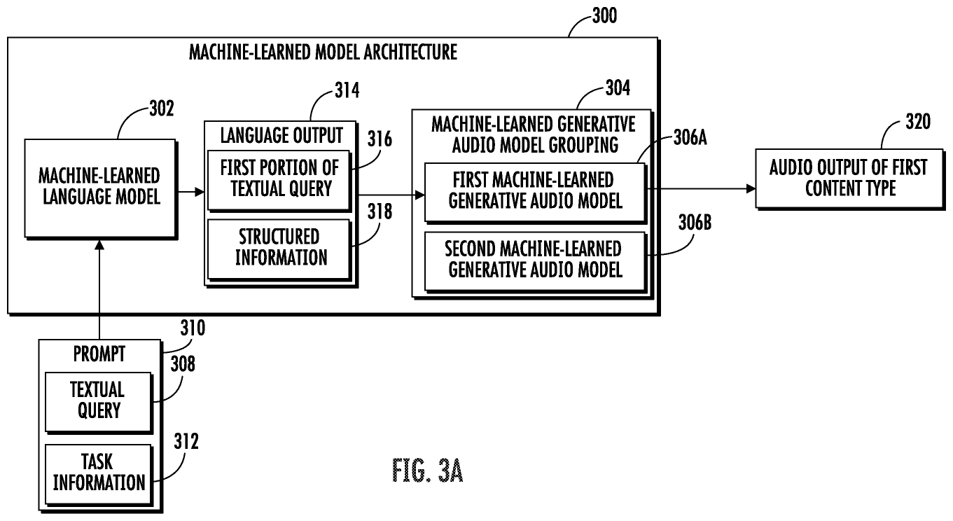

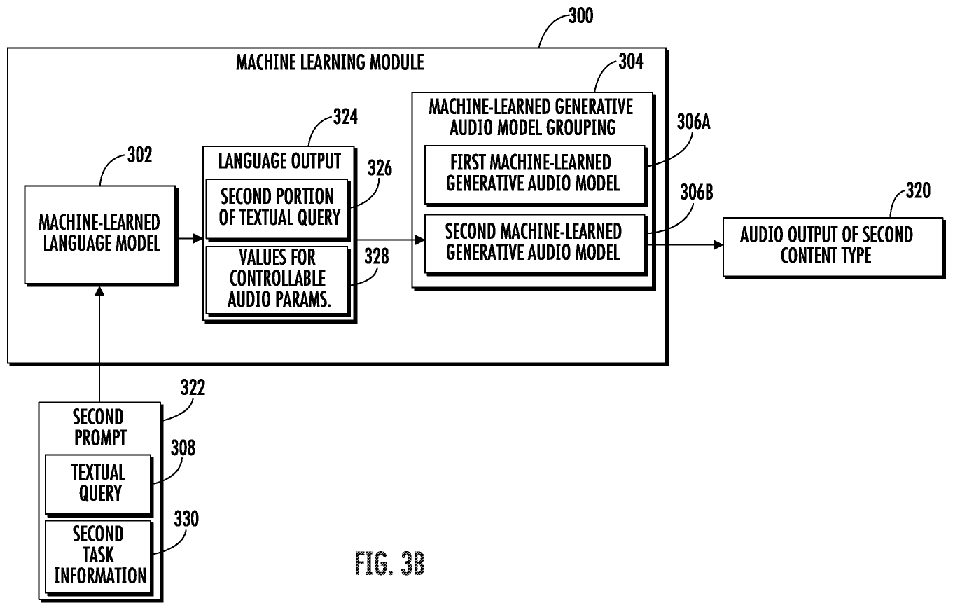

FIG. 3A depicts a data flow diagram of an example machine learning module 300 that optimizes selection of a first portion of a textual query as an input for a first generative audio model according to example embodiments of the present disclosure. The machine learning module 300 can be a module that can utilize a plurality of different machine-learned models to generate an output based on a received input. The machine learning module 300 includes a machine-learned language model 302. In some implementations, the machine-learned language model 302 can be a pre-trained large language model that is broadly trained for performance of a variety of language tasks. In some implementations, the machine-learned language model 302 can be a large language model that has undergone additional tuning for selection of portions of a textual query for input to task-specific machine-learned generative audio models. Alternatively, in some implementations, the machine-learned language model can be a task-specific language model trained for selection of portions of a textual query for input to task-specific machine-learned generative audio models.

The machine learning module 300 can include a machine-learned generative audio model grouping 304. The machine-learned generative audio model grouping 304 can include a plurality of task-specific machine-learned generative audio models. In particular, the machine-learned generative audio model grouping 304 can include a first machine-learned generative audio model 306A and a second machine-learned generative audio model 306B. The machine-learned generative audio models 306A and 306B can be trained to perform certain generative audio tasks (e.g., speech generation, music generation, background audio generation, generalized audio generation, etc.).

The machine-learned language model 302 of the machine learning module 300 can process a textual query 308. The textual query 308 can request a certain manner of audio output that necessitates the performance of multiple generative audio tasks. It should be noted that the textual query 308 is not necessarily formatted as a question. Rather, the textual query 308 can merely specify a type of audio to be produced, or a scenario in which audio would be produced (e.g., “two people whispering to each other during a movie”).

In some implementations, the textual query 308 can be included in a prompt 310 along with task information 312. The task information 312 can indicate a task for the machine-learned language model 302 to perform. For example, the task information 312 may instruct the machine-learned language model 302 to select a portion of the textual query 308 as an input to the first machine-learned generative audio model 306A. For another example, the task instructions may instruct the machine-learned language model 302 to select two different portions of the textual query 308 as inputs for both the first machine-learned generative audio model 306A and the second machine-learned generative audio model 306B.

In some implementations, the textual query 308, and/or the prompt 310, can be produced using a machine-learned model (e.g., machine-learned language model 302, etc.). For example, a user can provide a textual query as an initial prompt for a machine-learned generative language model (e.g., “write a poem about X, write a descriptive paragraph about X, etc.). The output of the machine-learned generative model can be used as textual query 308.

The machine-learned language model 302 can process the textual query 308, and/or the prompt 310, to obtain a language output 314. In some implementations, the language output 314 can be textual content that includes a portion of the textual query 308. For example, assume that the task information 312 instructs the machine-learned language model 302 to select a portion of the textual query 308 as an input for the first machine-learned generative audio model 306A, which can be a generative music model. If the textual query 308 includes textual content “Two people yelling at each other during a rock concert”, the machine-learned language model 302 may generate a language output 314 that includes a first portion 316 of the textual query 308 as an input for the first machine-learned generative audio model 306A (e.g., “A rock concert”).

Additionally, or alternatively, in some implementations, the language output 314 can include structured information 318 derived from the first portion 316 of the textual query 308. To follow the previous example, the textual query 308 can include the textual content “A rock concert”). The structured information 318 can be a textual data object that parameterizes or otherwise structures the portion selected from the textual query 308. For example, the structured information 318 can be a Javascript Object Notation (JSON) data object that structures the portion of the textual query 308 as parameters for the first machine-learned generative audio model 306A in the following manner:

```
{
  TASK: MUSIC_GEN;
  GENRE: ROCK;
  SUBGENRE: NA;
  ENV: LIVE_VENUE;
}.
```

It should be noted that the previously illustrated example is only one manner in which the structured information 318 can be structured. Rather, the structured information 318 can be structured in any manner, and/or can include any type of information derived from the first portion 316 of the textual query 308. In particular, in some implementations, the machine-learned language model 302 may generate predicted information related to the textual query 308. For example, assume that the textual query 308 includes “One person singing along to pop music outside.” The machine-learned language model 302 can process the prompt 308 to generate structured information 318 based on a first portion 316 of the textual query 308 (e.g., “pop music outside”). The machine-learned language model 302 may predict that the “pop music outside” would occur in an outdoor live music venue, and may include the prediction in the structured information 318 (e.g., ENV: LIVE_VENUE; OUTDOORS).

As described previously, in some implementations, the machine-learned language model 302 can be used to generate a language output 314 that selects a plurality of portions of the textual query 308 for a respective plurality of generative audio models of the machine-learned generative audio model grouping 304. In some implementations, the machine-learned language model 302 can be instructed to select the plurality of portions of the textual query 308 by the task information 312. Alternatively, in some implementations, the machine-learned language model 302 may select a plurality of portions of the textual query 308 by default and as such not require any instructions via task information 312.

In some implementations, the structured information 318 may annotate the textual query 308. For example, assume that the machine-learned language model 302 processes a textual query 308 that includes “A man saying: ‘I'd like to say something’ with a train passing by in the distance”. The structured information may annotate the textual query 308 with information that demarcates the first portion 316 as an input for the first machine-learned generative audio model 306A. For example, if the first machine-learned generative audio model 306A is a generative speech model, the structured information 318 may annotate textual query 308 with structural language, such as <s>, to indicate the first portion 316 of the textual query 308 as the input for the first machine-learned generative audio model 306A in the following manner: “A man saying: <s>I'd like to say something<s/> with a train passing by in the distance”). Additionally, or alternatively, in some implementations, the structured information 318 may structure the first portion 316 of the textual query 308 as an input for the first machine-learned generative audio model 306A. To follow the previous example, the structured information 318 may structure the first portion 316 in the following manner:

```
Speech Input:
  <speech>
    <speaker>male</speaker>
    <transcript>I'd like to say something</transcript>
  </speech>
```

The first machine-learned generative audio model 306A can be utilized to process the language output 314 to obtain an audio output 320. The audio output 320 can include audio that corresponds to the specific generative audio task that the first machine-learned generative audio model 306A is trained to perform. To follow the previous example, if the first portion of the textual query 308 includes the textual content “pop music outside”, the first machine-learned generative audio model 306A can generate audio output 320 of the first content type that includes audio of pop music in an outdoor venue.

FIG. 3B depicts a data flow diagram of the example machine learning module 300 that optimizes selection of a second portion of the textual query as an input for a second generative audio model according to example embodiments of the present disclosure. In particular, in addition to generating a language output 314 that includes a first portion 316 of the textual query 308, the machine learning module 300 can process a second prompt 322 with the machine-learned language model to obtain a second language output 324, which can include a second portion 326 of the textual query 308 and values for controllable audio parameters 328.

In some implementations, the machine learning module 300 can generate the language output 324 subsequent to generation of the language output 316 of FIG. 3A. For example, the machine learning module 300 can select the first portion 316 of the textual query 308 as an input to the first machine-learned generative audio model 306, and after processing the first portion 316 of the textual query 308 with the first machine-learned generative audio model 306A to obtain the audio output 320, can select a second portion 326 of the textual query 308 as an input for the second machine-learned generative audio model in the same manner. Alternatively, in some implementations, the first portion 316 and the second portion 326 of the textual query 308 can be selected in parallel using the machine-learned language model 302. For example, the machine learning module 300 may instantiate two instances of the machine-learned language model 302 for parallel selection of the first and second portions 316/326. For another example, the machine learning module 300 can instruct the machine-learned language model 302 (e.g., via task information 312) to concurrently select the first portion 316 and the second portion 326 from the textual query 308.

In some implementations, the machine learning module 300 can process a second prompt 322 with the machine-learned language model 302. The second prompt 322 can include the textual query 308 and second task information 330. The second task information 330 can instruct the machine-learned language model 302 to select a portion of the textual query 308 as an input for the second machine-learned generative audio model 306B. In such fashion, by iteratively providing the textual query 308 and new task information to the machine-learned language model 302, the machine learning module 300 can select an input from the textual query 308 for every generative audio model included in the machine learning module as long as the input is included in the textual query 308.

For example, assume that the textual query 308 includes “background ambience from a busy Café with jazz music playing in the background”, and that the second task information 330 instructs the machine-learned language model 302 to select a portion of the textual query 308 as an input for the second machine-learned generative audio model 306B. If the second machine-learned generative audio model 306B is trained to generate background audio, the machine-learned language model 302 can generate a language output 324 that includes “background ambience from a busy Café” as second portion 326 of the textual query 308. However, if the second machine-learned generative audio model 306B is trained to generate audio of a speech content type, the machine-learned language model 302 can generate a language output 324 that includes “NA” or a blank line for the second portion 326 of the textual query 308. Based on the lack of any portion of the textual query 308 within the language output 324, the machine learning module 300 can determine that utilization of the second machine-learned generative audio model 306B is not required.

More generally, the machine learning module 300 can iteratively instruct the machine-learned language model 302 to select portions of the textual query 308 as inputs for subsequent machine-learned generative audio models included in the machine-learned generative audio model grouping 304. If the machine-learned language model 302 provides a language output (e.g., outputs 314 and 324) that includes a portion of the textual query 308, the machine learning module 300 can process the portion of the textual query with the corresponding model of the machine-learned generative audio model grouping 304. If the machine-learned language model 302 does not provide a language output that includes a portion of the textual query 308, the machine learning module 300 can provide instructions to select a portion of the textual query 308 as an input for a subsequent model of the machine-learned generative audio model grouping 304. In such fashion, the machine learning module 300 can process portions of the textual query 308 with certain models of the machine-learned generative audio model grouping 304 without foreknowledge of which models should be used.

To follow the depicted example, the machine-learned language model 302 can process the second prompt 322. The second task information 330 can instruct the machine-learned language model 302 to select a portion 326 of the textual query 308 as an input for the second machine-learned generative audio model 306B. Based on the second prompt 322, the machine-learned language model 302 can generate a language output 324 that includes a second portion 326 of the textual query 308. The machine learning module 300 can process the language output 324 with the second machine-learned generative audio model 306B to obtain an audio output 320 of the second content type.

In some implementations, the language output 324 can include values for controllable audio parameters 328. The values for controllable audio parameters 328 can be values for parameters of the second machine-learned generative audio model 306B that are extracted, or otherwise predicted, from the textual query 308. For example, assume that the second machine-learned generative audio model is trained to generate audio of a speech content type, and has a controllable gender parameter that controls a gender of a speaker producing audio. If the second portion 326 of the textual query 308 includes “a man speaking to a crowd at a presentation”, the values for the controllable audio parameters 328 can include a value of “male” for the controllable gender parameter of the second machine-learned generative audio model 306B. The machine learning module 300 can control the controllable parameters of the model to input the values for the controllable audio parameters 328. The audio output 320 of the second content type can include audio produced by a male voice speaking.

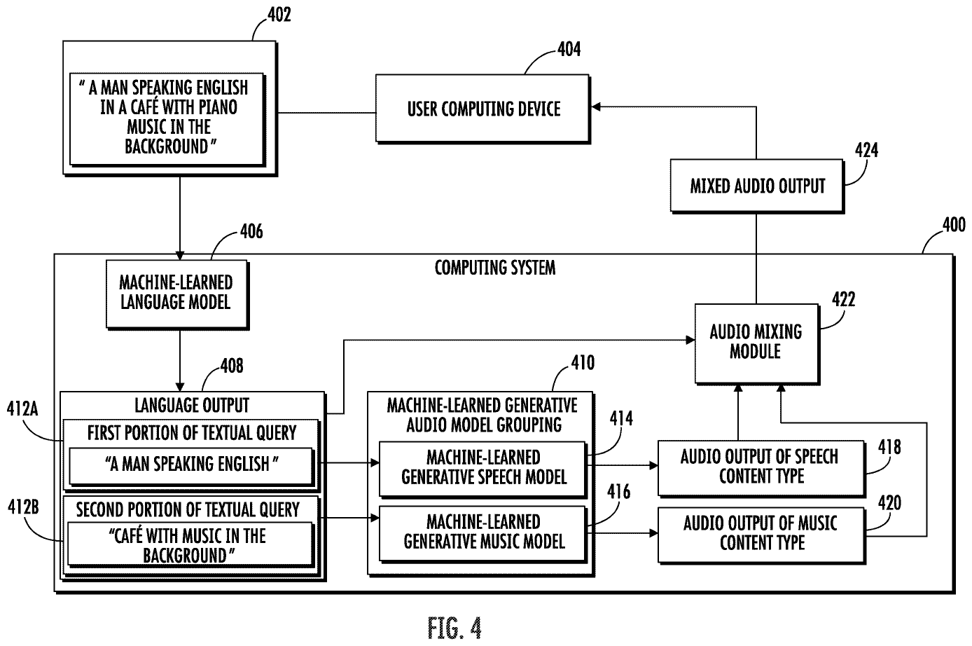

FIG. 4 is a data flow diagram for interactions between a user computing device and a computing system that provides a generative audio service using a machine learning module according to some implementations of the present disclosure. More specifically, a computing system 400 providing a generative audio service can receive a textual query 402 from a user computing device 404. The computing system 400 can process the textual query with a machine-learned language model 406 as described with regards to FIGS. 3A-3B to obtain a language output 408. The language output 408 can indicate portions of the textual query 402 as being inputs for machine-learned generative audio models of a machine-learned generative audio model grouping 410.

To follow the depicted example, the machine-learned language model 406 can process the textual query 402 that includes the textual content “a man speaking English in a Café with piano music in the background.” Based on the textual query 402, the machine-learned language model 406 can generate a language output 408. The language output 408 can indicate a first portion 412A of the textual query 402 that includes the textual content “a man speaking English” as being an input for a machine-learned generative speech model 414 of the machine-learned generative audio model grouping 410. The language output 408 can indicate a second portion 412B of the textual query 402 that includes the textual content “café with music in the background” as being an input for a machine-learned generative music model 416 of the machine-learned generative audio model grouping 410.

The machine-learned generative speech model 414 can be a model trained to generate an audio output of a speech content type based on a text input. The machine-learned generative speech model 414 can process the first portion 412A of the textual query 402 to obtain an audio output 418 that includes audio of the speech content type. Similarly, the machine-learned generative music model 416 can be a model trained to generate an audio output of a music content type based on a text input. The machine-learned generative music model 416 can process the second portion 412B of the textual query 402 to obtain an audio output 420 that includes audio of the music content type.

The computing system 400 can mix the audio output 418 with the audio output 420 using an audio mixing module 422 to obtain a mixed audio output 424. The audio mixing module 422 can be any type or manner of software and/or hardware that enable conventional audio mixing techniques. In some implementations, the audio mixing module 422 can mix the audio outputs 418 and 420 based at least in part on information included in the language output 408. For example, the language output 408 can include the second portion 412B of the textual query 402 “café with music in the background”. The language output 408 can indicate that the volume of an audio output generated using the second portion 412B of the textual query 402 should be mixed to have a lower volume than other audio outputs based on the inclusion of the word “background.” In some implementations, this indication may be included in structured information (e.g., structured information 318 of FIG. 3A) and provided to the audio mixing model. More generally, any semantic understanding, or inference, that is generated by the machine-learned language model 406 based on the textual query 402 can be utilized by the computing system 400 to modify parameters of the audio mixing module 422.

The mixed audio output 424 can be provided to the user computing device 404 (e.g., via a wireless network, etc.). In such fashion, the computing system 400 can provide a generative audio service that provides accurate outputs using efficient, task-specific machine-learned generative models.

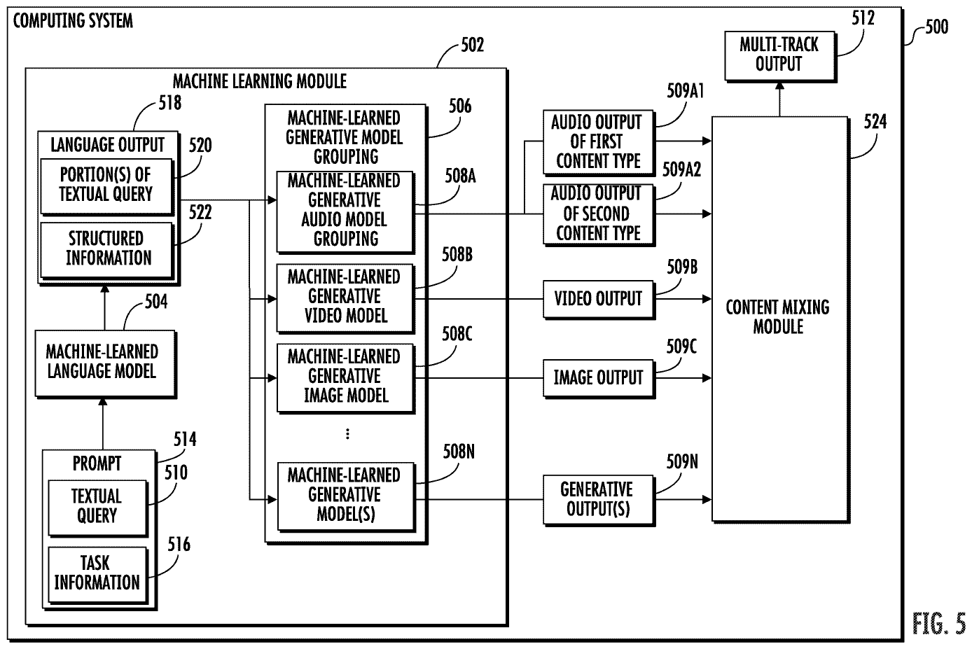

FIG. 5 is a data flow diagram for generation of a multi-track output using a machine-learned generative model grouping that includes multiple generative models trained to generate different types of content according to some implementations of the present disclosure. Specifically, a computing system 500 can include a machine learning module 502. The machine learning module 502 can be a module that can utilize a plurality of different machine-learned models to generate an output based on a received input. The machine learning module 502 includes a machine-learned language model 504. In some implementations, the machine-learned language model 504 can be a pre-trained large language model that is broadly trained for performance of a variety of language tasks. In some implementations, the machine-learned language model 504 can be a large language model that has, or has not, undergone additional tuning for selection of portions of a textual query for input to task-specific machine-learned generative models. Alternatively, in some implementations, the machine-learned language model 504 can be a task-specific language model trained for selection of portions of a textual query for input to task-specific machine-learned generative models.

The machine learning module 502 can include a machine-learned generative model grouping 506. The machine-learned generative model grouping 506 can include a plurality of task-specific machine-learned generative models. In particular, the machine-learned generative audio model grouping 506 can include a machine-learned generative audio model grouping 508A. The machine-learned generative audio model grouping 508A can include one or more task-specific generative audio models for generation of audio of different audio content types. For example, the machine-learned generative audio model grouping 508A can include a first generative audio model trained to generate an audio output 509A1 of a first audio content type (e.g., a speech audio content type, etc.) and a second generative audio model trained to generate an audio output 509A2 of a second audio content type (e.g., a music audio content type, etc.).

In some implementations, the machine-learned generative model grouping 506 can include a machine-learned generative video model 508B. The generative video model 508B can be a model trained to generate a video output 509B of one or more video content types. For example, the generative video model 508B can be a foundational video model trained to perform multiple types of generative video tasks (e.g., photorealistic video data, animated video data, etc.). The generative video model 508B can process a textual input that is indicative of a certain task to obtain the video output 509B based on the certain task.

In some implementations, the machine-learned generative model grouping 506 can include a machine-learned generative image model 508C. The generative image model 508C can be a model trained to generate an image output 509C of one or more image content types (e.g., art, photography, three-dimensional renderings, etc.). For example, the generative image model 508B can be a foundational image model trained to perform multiple types of generative image tasks. The generative image model 508C can process a textual input that is indicative of a certain task to generate an image output 509C that corresponds to the certain task.

In some implementations, the machine-learned generative model grouping 508 can include one or more additional machine-learned generative model(s) 508N. The machine-learned generative model(s) 508N can be, or otherwise include, any type or manner of generative model that can generate generative output(s) 509N for inclusion in a multi-track output, or to facilitate creation of a multi-track output. For example, the machine-learned generative model(s) 508N can include models trained to generate outputs 509N such as three-dimensional rendering data, implicit representation data, pose data, upscaled image data, encoded or compressed data, etc.

The machine-learned language model 504 of the machine learning module 502 can process a textual query 510. The textual query 510 can request a certain manner of multi-track output 512 that necessitates the performance of multiple generative tasks. It should be noted that the textual query 510 is not necessarily formatted as a question. Rather, the textual query 510 can merely specify multiple types of content to be produced, or a scenario in which content would be produced (e.g., “A classic rock song titled ‘Hotel Carolina’ with accompanying music video and album art”).

In some implementations, the textual query 510 can be included in a prompt 514 along with task information 516. The task information 516 can indicate multiple tasks for the models of the machine-learned generative model grouping 506 to perform. For example, the task information 516 may instruct the machine-learned generative model grouping 506 to select a portion of the textual query 510 as an input to the machine-learned generative audio model grouping 508A, and a second portion of the textual query 510 as an input to the machine-learned generative video model 508B. For another example, the task information 516 may specify requested content types (e.g., an image output, an audio output, and a video output).

The machine-learned language model 504 can process the textual query 510, and/or the prompt 514, to obtain a language output 518. In some implementations, the language output 518 can be textual content that includes a portion of the textual query 510. For example, assume that the task information 516 instructs the machine-learned generative model grouping 506 to select a portion of the textual query 510 as an input for a generative music model of the machine-learned generative audio model grouping 508A (e.g., a generative model trained to generate audio of a music audio content type). If the textual query 510 includes textual content “Two people yelling two each other during a rock concert”, the machine-learned language model 302 may generate a language output 518 that includes portion(s) 520 of the textual query 510 as an input for a model of the machine-learned generative audio model grouping 508A (e.g., “A rock concert”).

Additionally, or alternatively, in some implementations, the language output 314 can include structured information 522 derived from the first portion 316 of the textual query 308. To follow the previous example, the textual query 510 can include the textual content “a classic rock song with accompanying cover art for an album and a music video”). The structured information 522 can be a textual data object that parameterizes or otherwise structures the portion selected from the textual query 510. For example, the structured information 318 can be a Javascript Object Notation (JSON) data object that structures the portion of the textual query 510 as parameters for models of the machine-learned generative model grouping 506 in the following manner:

```
{
  MODEL: GEN_AUD_MUSIC_MODEL
  TASK: MUSIC_GEN;
  GENRE: ROCK;
  SUBGENRE: NA;
  ENV: LIVE_VENUE;
}
{
  MODEL: GEN_VIDEO_MODEL
  TASK: MUSIC_VIDEO;
  GENRE: ROCK;
  SUBGENRE: CLASSIC;
  ENV: STUDIO;
  REL: GEN_AUD_MUSIC_MODEL
}
{
  MODEL: GEN_IMAGE_MODEL
  TASK: ART;
  TYPE: ‘Cover art for an album’
  STYLE: N/A
  REL: GEN_AUD_MUSIC_MODEL
}
```

The structured information 522 illustrated above can provide structured inputs for the machine-learned generative audio model grouping 508A, the machine-learned generative video model 508B, and the machine-learned generative image model 508C.

In some implementations, the language output 518 can include multiple language outputs that are each tailored to a particular model. The multiple language outputs 518 can be generated concurrently or sequentially by the machine-learned language model 504. To follow the previous example, a first language output 518 can include structured information 522 formatted for the machine-learned generative audio model grouping 508A, and which structures a first portion 520 of the textual query 510. A second language output 518 can include structured information 522 formatted for the machine-learned generative video model 508B, and which structures a second portion 520 of the textual query 510.

The generative models of the machine-learned generative model grouping 506 can process language output(s) 518 to generate generative outputs 509A1-509N (generally, generative outputs 509). The computing system 500 can process the generative outputs 509 with a content mixing module 524 to obtain the multi-track output 512. The multi-track output 512 can be structured data that includes multiple tracks corresponding to the multiple content types of the generative outputs 509. For example, assume that the generative outputs 509 include an audio output of a first content type 509A1, an audio output of a second content type 509A2, and a video output 509B. The multi-track output 512 can mix the generative outputs 509 such that each of the outputs 509A1, 509A2, and 509B can be separately edited by a user. In other words, the multi-track output 512 retains the capacity to separately edit each of the generative outputs 509 included in the multi-track output 512.

It should be noted that, in some implementations, the machine-learned generative audio models of the machine-learned generative audio model grouping 508A, and/or the machine-learned generative video model 508B, can be audiovisual models trained to perform specific audiovisual tasks. For example, assume that the textual query 510 includes “a quiet conversation being held while watching a music video for a classic rock song”. The machine-learned language model 504 can process the textual query 510 to generate a language output 518. Assume that the machine-learned generative audio model grouping 508A includes a generative speech audio model trained to generate audio of a speech audio content type, and that the machine-learned generative video model 508B is capable of producing audiovisual outputs. The structured information 522 of the language output 518 can indicate that a first portion 520 of the textual query 510 is to be processed by the machine-learned generative speech audio model (e.g., “a quiet conversation”) and a second portion 520 of the textual query 510 is to be processed by the machine-learned generative video model 508B (e.g., “watching a music video for a classic rock song.” The machine-learned generative video model 508B can process the input to generate an audiovisual output that includes audio (e.g., the classic rock song) and video (e.g., the corresponding music video).

In such fashion, implementations of the present disclosure can be utilized to generate a multi-track output 512 that includes generative outputs 509 generated using multiple types of generative models included in a machine-learned generative model grouping 506. In particular, a textual query 510 can be parsed (e.g., using machine-learned language model 504) to identify which generative models are to be utilized, and to specify inputs for the models.

### Example Methods

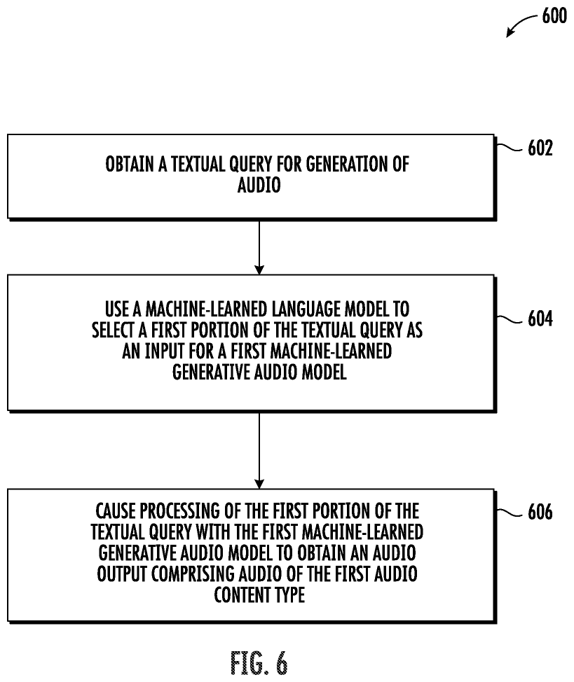

FIG. 6 depicts a flow chart diagram of an example method 600 to perform machine-learned selection of textual inputs for generative audio models according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain a textual query for generation of audio. The generation of audio can be performed with a machine-learned generative audio model grouping that includes a plurality of machine-learned generative audio models each trained to generate audio of a respective audio content type of a plurality of audio content types. For example, a first machine-learned generative audio model can be trained to generate audio of a speech content type, and another machine-learned generative audio model can be trained to generate audio of a background audio type.

At 604, the computing system can use a machine-learned language model to select a first portion of the textual query as an input for a first machine-learned generative audio model of the plurality of machine-learned generative audio models. The first machine-learned generative audio model can be trained to generate audio of a first audio content type of the plurality of audio content types.

In some implementations, the first machine-learned generative audio model can be a machine-learned speech generation model trained to generate audio of a speech content type based on a text input. Alternatively, in some implementations, the first machine-learned generative audio model can be a machine-learned music generation model trained to generate audio of a music content type based on a text input. Alternatively, in some implementations, the first machine-learned generative audio model can be a machine-learned generalized audio model trained to generate generalized audio of one or more audio content types based on a text input.

In some implementations, the computing system can use the language model to select the first portion of the textual query by processing a prompt with the machine-learned language model to obtain a language output indicating the first portion of the textual query as being an input for the first machine-learned generative audio model of the plurality of machine-learned generative audio models. The prompt can include the textual query and information indicative of a task to determine whether the textual query includes an input for the first machine-learned generative audio model.

In some implementations, the first machine-learned generative audio model is trained to generate audio of the first audio content type based on one or more controllable audio parameters. The textual query can describe values for the one or more controllable audio parameters. The prompt can further include the values for the one or more controllable audio parameters.

In some implementations, the first machine-learned generative audio model can be a machine-learned music generation model trained to generate audio of a music content type. The one or more controllable audio parameters can include at least one of a musical genre parameter, a relative volume parameter that controls a volume of the audio of the music content type relative to audio of other content types, or an instrument parameters that controls types of instruments to be included in the audio of the music content type.

Alternatively, in some implementations, the first machine-learned generative audio model can include a machine-learned speech generation model trained to generate audio of a speech content type. The one or more controllable audio parameters can include at least one of a gender parameter that controls a gender of the speaker producing the audio of the speech content type, a relative volume parameter that controls a volume of the audio of the speech content type relative to audio of other content types, or an emotional state parameter that controls an emotional state of the speaker producing the audio of the speech content type.

Alternatively, in some implementations, the first machine-learned generative audio model comprises a machine-learned generalized audio model trained to generate generalized audio of one or more miscellaneous audio content types. The one or more controllable audio parameters can include at least one of a content type parameter that controls the one or more miscellaneous audio content types of the generalized audio to be generated or a relative volume parameter that controls a volume of the audio of the generalized relative to audio of other content types.

In some implementations, in addition to selecting the first portion of the textual query, the computing system can use the machine-learned language model to modify the first portion of the textual query. For example, the machine-learned language model can process the prompt with the machine-learned language model. The output of the machine-learned language model can be a modified portion of the textual query. For example, the machine-learned language model may modify the portion of the textual query to be more specifically formatted for subsequent processing, to supplement the query, etc.

At 606, the computing system can cause processing of the first portion of the textual query with the first machine-learned generative audio model to obtain an audio output comprising audio of the first audio content type.

In some implementations, the computing system can further use the machine-learned language model to select a second portion of the textual query as an input for a second machine-learned generative audio model of the plurality of machine-learned generative audio models. The second machine-learned generative audio model can be trained to generate audio of a second audio content type of the plurality of audio content types. The computing system can cause processing of the second portion of the textual query with the second machine-learned generative audio model to obtain a second audio output comprising audio of the second audio content type.

In some implementations, the computing system can use the machine-learned language model to determine that the textual query does not include an input for a third machine-learned generative audio model of the plurality of machine-learned generative audio models, The third machine-learned generative audio model can be a model trained to generate audio of a third audio type of the plurality of audio content types. For example, assume that the first and second generative audio models are trained to generate audio of a music content type and a background noise content type, respectively. The third generative audio model can be trained to generate audio of a speech content type. The textual query can include the text “live acoustic guitar music played in a busy café.” The first portion of the textual query processed by the first generative audio model can include “live acoustic guitar music”, and the second portion of the textual query processed by the second generative audio model can include “played in a busy café.” However, as no portion of the textual query is related to audio of a speech content type, an output of the machine-learned language model can indicate that the textual query does not include an input for the third generative audio model.

In some implementations, the textual query can be obtained from a user computing device associated with a user. The computing system can mix the audio output and the second audio output to obtain a mixed audio output that includes a mix of the audio of the first content type and the audio of the second content type. The computing system can provide the mixed audio output to the user computing device. In some implementations, mixing the audio output and the second audio output may concatenate the audio outputs. For example, if the textual query is “a person speaking, followed by jazz music playing”, the first output is a person speaking, and the second audio output is jazz music, then mixing the first and second audio outputs may include concatenating the first audio output with the second audio output.

In some implementations, causing processing of the first portion of the textual query with the first machine-learned generative audio model to obtain an audio output comprising audio of the first audio content type can include providing the first portion of the textual query to a computing device that includes an instance of the first machine-learned generative audio model. Responsive to providing the first portion of the textual query, the computing system can receive, from the computing device, the audio output comprising the audio of the first audio content type. For example, the computing system can be a compute node or server computing system within a wider network of computing devices that collectively provide services, such as a generative audio service. Within the network, a computing device can be utilized to instantiate instances of machine-learned models for processing. The computing system can provide the first portion of the textual query to such a computing device.

Alternatively, in some implementations, causing processing of the first portion of the textual prompt with the first machine-learned generative audio model to obtain the audio output comprising audio of the first audio content type can include processing the first portion of the textual query with the first machine-learned generative audio model to obtain the audio output that includes the audio of the first audio content type.

It should be noted that implementations of the present disclosure are not limited to generation of audio data or machine-learned generative audio models. Rather, implementations of the present disclosure may also be utilized in the context of image data, video data, AR/VR data, audiovisual data, etc.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, comprising:
obtaining, by a computing system comprising one or more computing devices, a textual query for generation of audio, wherein the generation of audio is performed with a machine-learned generative audio model grouping comprising a plurality of machine-learned generative audio models each trained to generate audio of a respective audio content type of a plurality of audio content types;
using, by the computing system, a machine-learned language model to select a first portion of the textual query as an input for a first machine-learned generative audio model of the plurality of machine-learned generative audio models, wherein the first machine-learned generative audio model is trained to generate audio of a first audio content type of the plurality of audio content types;
generating, by the machine-learned language model, a prediction based on the first portion of the textual query, wherein the prediction comprises one or more controllable audio parameters predicted to be associated with the first portion of the textual query; and
causing, by the computing system, processing of the first portion of the textual query and the prediction with the first machine-learned generative audio model to obtain an audio output comprising audio of the first audio content type.

2. The computer-implemented method of claim 1, wherein the method further comprises:
using, by the computing system, the machine-learned language model to select a second portion of the textual query as an input for a second machine-learned generative audio model of the plurality of machine-learned generative audio models, wherein the second machine-learned generative audio model is trained to generate audio of a second audio content type of the plurality of audio content types; and
causing, by the computing system, processing of the second portion of the textual query with the second machine-learned generative audio model to obtain a second audio output comprising audio of the second audio content type.

3. The computer-implemented method of claim 2, wherein the method further comprises:
using, by the computing system, the machine-learned language model to determine that the textual query does not include an input for a third machine-learned generative audio model of the plurality of machine-learned generative audio models, wherein the third machine-learned generative audio model is trained to generate audio of a third audio content type of the plurality of audio content types.

4. The computer-implemented method of claim 2, wherein obtaining the textual query comprises obtaining, by the computing system, the textual query for the generation of audio from a user computing device; and
wherein the method further comprises:
mixing, by the computing system, the audio output and the second audio output to obtain a mixed audio output comprising a mix of the audio of the first audio content type and the audio of the second audio content type; and
providing, by the computing system, the mixed audio output to the user computing device.

5. The computer-implemented method of claim 1, wherein the first machine-learned generative audio model comprises:
a machine-learned speech generation model trained to generate audio of a speech content type based on a text input;
a machine-learned music generation model trained to generate audio of a music content type based on a text input; or
a machine-learned generalized audio model trained to generate generalized audio of one or more audio content types based on a text input.

6. The computer-implemented method of claim 2, wherein using the machine-learned language model to select the second portion of the textual query as the input for the second machine-learned generative audio model of the plurality of machine-learned generative audio models comprises:
processing, by the computing system, a prompt with the machine-learned language model to obtain a language output indicating the first portion of the textual query as being an input for the first machine-learned generative audio model of the plurality of machine-learned generative audio models, wherein the prompt comprises the textual query and information indicative of a task to determine whether the textual query includes an input for the first machine-learned generative audio model.

7. The computer-implemented method of claim 6, wherein:
the first machine-learned generative audio model is trained to generate audio of the first audio content type based on one or more controllable audio parameters;
the textual query is descriptive of values for the one or more controllable audio parameters; and
the prompt further comprises the values for the one or more controllable audio parameters.

8. The computer-implemented method of claim 7, wherein:
the first machine-learned generative audio model comprises a machine-learned music generation model trained to generate audio of a music content type; and
the one or more controllable audio parameters comprises at least one of:
a musical genre parameter;
a relative volume parameter that controls a volume of the audio of the music content type relative to audio of other content types; or
an instrument parameter that controls types of instruments to be included in the audio of the music content type.

9. The computer-implemented method of claim 7, wherein:
the first machine-learned generative audio model comprises a machine-learned speech generation model trained to generate audio of a speech content type; and
the one or more controllable audio parameters comprises at least one of:
a gender parameter that controls a gender of a speaker producing the audio of the speech content type;
a relative volume parameter that controls a volume of the audio of the speech content type relative to audio of other content types; or
an emotional state parameter that controls an emotional state of the speaker producing the audio of the speech content type.

10. The computer-implemented method of claim 7, wherein the first machine-learned generative audio model comprises a machine-learned generalized audio model trained to generate generalized audio of one or more miscellaneous audio content types; and
the one or more controllable audio parameters comprises at least one of:
a content type parameter that controls the one or more miscellaneous audio content types of the generalized audio to be generated; or
a relative volume parameter that controls a volume of the generalized audio relative to audio of other content types.

11. The computer-implemented method of claim 1, wherein causing processing of the first portion of the textual query with the first machine-learned generative audio model to obtain the audio output comprising audio of the first audio content type comprises:
providing, by the computing system, the first portion of the textual query to a computing device that includes an instance of the first machine-learned generative audio model; and
responsive to providing the first portion of the textual query, receiving, by the computing system from the computing device, the audio output comprising the audio of the first audio content type.

12. The computer-implemented method of claim 1, wherein causing processing of the first portion of the textual query with the first machine-learned generative audio model to obtain the audio output comprising audio of the first audio content type comprises:
processing, by the computing system, the first portion of the textual query with the first machine-learned generative audio model to obtain the audio output comprising the audio of the first audio content type.

13. A computing system, comprising:
one or more processors;
one or more non-transitory computer-readable media that store instructions that, when executed by the one or more processors, cause the one or more processors to perform operations, the operations comprising:
obtaining a textual query for generation of audio, wherein the generation of audio is performed with a machine-learned generative audio model grouping comprising a plurality of machine-learned generative audio models each trained to generate audio of a respective audio content type of a plurality of audio content types;
using a machine-learned language model to respectively select one or more portions of the textual query as inputs for one or more machine-learned generative audio models of the plurality of machine-learned generative audio models; wherein the one or more machine-learned generative audio models are trained to generate audio of one or more respective audio content types of a plurality of audio content types;
generating, by the machine-learned language model, a prediction based on the one or more portions of the textual query, wherein the prediction comprises one or more controllable audio parameters predicted to be associated with the one or more portions of the textual query; and
causing processing of the one or more portions of the textual query and the prediction with the one or more machine-learned generative audio models to obtain one or more audio outputs comprising audio of the one or more respective audio content types.

14. The computing system of claim 13, wherein obtaining the textual query comprises obtaining, from a user computing device, the textual query for generation of audio; and
wherein the operations further comprise providing the one or more audio outputs to the user computing device.

15. The computing system of claim 14, wherein the operations further comprise:
receiving, from the user computing device, user feedback information descriptive of user feedback for the one or more audio outputs; and
based on the user feedback information, adjusting values of one or more parameters of the machine-learned language model.

16. The computing system of claim 13, wherein the one or more machine-learned generative audio models comprise at least one of:
a machine-learned speech generation model trained to generate audio of a speech content type based on a text input;
a machine-learned music generation model trained to generate audio of a music content type based on a text input; or
a machine-learned generalized audio model trained to generate generalized audio of one or more audio content types based on a text input.

17. The computing system of claim 13, wherein using the machine-learned language model to respectively select the one or more portions of the textual query as inputs for the one or more machine-learned generative audio models comprises:
processing a prompt with the machine-learned language model to obtain a language output indicating the one or more portions of the textual query as being inputs for the one or more machine-learned generative audio models, wherein the prompt comprises the textual query and information indicative of a task to determine whether the textual query includes inputs for the one or more machine-learned generative audio models.

18. The computing system of claim 17, wherein a first machine-learned generative audio model of the one or more machine-learned generative audio models is trained to generate audio of a first audio content type based on one or more controllable audio parameters;
the textual query is descriptive of values for the one or more controllable audio parameters; and
the prompt further comprises the values for the one or more controllable audio parameters.

19. The computing system of claim 18, wherein the first machine-learned generative audio model comprises a machine-learned music generation model trained to generate audio of a music content type; and
the one or more controllable audio parameters comprises at least one of:
a musical genre parameter;
a relative volume parameter that controls a volume of the audio of the music content type relative to audio of other content types; or
an instrument parameters that controls types of instruments to be included in the audio of the music content type.

20. One or more non-transitory computer-readable media that store instructions that, when executed by one or more processors, cause the one or more processors to perform operations, the operations comprising:
obtaining, from a user computing device, a textual query for generation of audio, wherein the generation of audio is performed with a machine-learned generative audio model grouping comprising a plurality of machine-learned generative audio models each trained to generate audio of a respective audio content type of a plurality of audio content types;
processing a prompt with a machine-learned language model to obtain a language output indicating two or more portions of the textual query as being inputs for two or more respective machine-learned generative audio models of the plurality of machine-learned generative audio models, wherein the prompt comprises the textual query and information indicative of a task to determine whether the textual query includes inputs for the two or more machine-learned generative audio models;
respectively processing the two or more portions of the textual query with the two or more machine-learned generative audio models to obtain two or more audio outputs comprising audio of two or more audio content types of the plurality of audio content types corresponding to the two or more machine-learned generative audio models, wherein respectively processing the two or more portions of the textual query comprises generating at least one prediction for the two or more portions of the textual query, wherein the at least one prediction comprises one or more controllable audio parameters predicted to be associated with the two or more portions of the textual query, and wherein the two or more audio outputs are based on both the two or more portions of the textual query and the at least one prediction;
mixing the two or more audio outputs to obtain a mixed audio output; and
providing the mixed audio output to the user computing device.
